(19) United States
(12) Patent Application Publication
(10) Pub. No.: US 2013/0161041 A1
(43) Pub. Date: Jun. 27, 2013

(54) APPARATUS FOR TIGHTENING THREADED FASTENERS

(71) Applicants: Eric P. Junkers, Saddle River, NJ (US); Peter Koppenhoefer, Portland, PA (US); Richard J. Raska, River Edge, NJ (US)

(72) Inventors: Eric P. Junkers, Saddle River, NJ (US); Peter Koppenhoefer, Portland, PA (US); Richard J. Raska, River Edge, NJ (US)

(21) Appl. No.: 13/577,995

(22) PCT Filed: Feb. 9, 2011
(86) PCT No.: PCT/IB11/01019

§ 371 Date: Feb. 5, 2013

Related U.S. Application Data
(60) Provisional application No. 61/302,598, filed on Feb. 9, 2010.
(60) Provisional application No. 61/430,105, filed on Jan. 5, 2011.

(51) Int. Cl. B25B 21/02; B25B 23/00; B25B 21/00

(52) U.S. Cl. CPC B25B 21/02; B25B 21/008; B25B 23/0078
USPC 173/48; 173/176; 173/94

(57) ABSTRACT

According to a first aspect of the invention we provide an apparatus for reaction—free and reaction—assisted tightening and loosening of an industrial fastener including: a motor (102) to generate a turning force to turn the fastener; a turning force multiplication mechanism (210) for a lower speed/higher torque mode including a plurality of turning force multiplication transmitters (211, 212, 213); a turning force impaction mechanism (250) for a higher speed/lower torque mode including a plurality of turning force impaction transmitters (251, 252); a housing (220) operatively connected with at least one multiplication transmitter; a reaction mechanism (401) to transfer a reaction force generated on the housing during the lower speed/higher torque mode to a stationary object; wherein during the lower speed/higher torque mode at least two multiplication transmitters rotate relative to the other; and wherein during the higher speed/lower torque mode at least two multiplication transmitters are unitary to achieve a hammering motion from the impaction mechanism.

### CROSS REFERENCE TO RELATED APPLICATIONS

This Application is a continuation application of co-pending U.S. Application Ser. No. 61/302,598, having Filing Date of Feb. 9, 2010, entitled “Torque Tool Having Intensifier and Impact Means”, and co-pending U.S. Application Ser. No. 61/430,105, having Filing Date of Jan. 5, 2011, entitled “An Apparatus for Tightening and Loosening an Industrial Fastener”, entire copies of which are incorporated herein by reference.

Innovations disclosed in this Application advance technology disclosed in the following commonly owned issued patents and patent applications, entire copies of which are incorporated herein by reference: U.S. application Ser. No. 11/745,014, having a Filing Date of May 7, 2007, entitled “Power-Driven Torque Intensifier”; U.S. Pat. No. 7,798,038, having Issue Date of Sep. 21, 2010, entitled “Reaction Arm For Power-Driven Torque Intensifier”; U.S. application Ser. No. 12/120,346, having a Filing Date of May 14, 2008, entitled “Safety Torque Intensifying Tool”; U.S. application Ser. No. 12/325,815, having a Filing Date of Dec. 1, 2008, entitled “Torque Power Tool”; and U.S. application Ser. No. 12/428,200, having a Filing Date of Apr. 22, 2009, entitled “Reaction Adaptors for Torque Power Tools and Methods of Using the Same”.

### DESCRIPTION OF INVENTION

Power driven torque intensifier tools are known through recent patent application disclosures. In a high speed, low torque first mode at least one intensifier mechanism turns together with the tool housing and the tool output drive. In a low speed, high torque second mode at least one intensifier mechanism turns in one direction while the housing tends to turn in the opposite direction. The housing is stopped from turning by means of a reaction fixture connected with a stationary object.

Often application characteristics adversely affect bolting jobs and include for example corroded, unclean, kinked, debris-laden, burred, galled, irregular, disoriented, misaligned and/or unevenly lubricated stud and nut threads and surfaces. Overcoming adverse bolting application characteristics many times is not feasible in the first mode.

Most impact mechanisms rely on a mass to be turned at high speed, which creates inertia that ends up into a hammering motion. Various impact mechanisms are known and may include at least one hammer which strikes an anvil while others may operate by vibration caused by interference between the power input and the drive output.

Some known impact mechanisms are effective in overcoming several adverse bolting application characteristics. The vibration absorbed by the operator at high torque, however, caused by the high mass of the impact mechanism is harmful. For example, European daily hand to arm vibration exposure action values from power tools is <2.5 m/s². Known hand-held, higher torque impact tools exceed this value. The torque output in the first mode therefore is limited to avoid harm to the operator.

Known low mass, low torque impact mechanisms may avoid vibration exposure harm to the operator and may be ideal for overcoming several adverse bolting application characteristics when running down or running off fasteners. Unfortunately they are ineffective at loosening highly torqued or corroded fasteners that are stuck to their joints and inadequate for higher torque needs which usually require torque precision.

Use of reaction fixtures at high turning speeds is known to cause injury. Harm commonly befalls operators' extremities when inadvertently in the wrong place as the reaction fixture can slam against a stationary object. The speed with which these tools operate is therefore limited.

A dual speed power driven torque intensifier tool recently disclosed operates at very high speed to run down or run off a nut without the need for reaction fixtures. This tool spins its housing together with its torque intensifier means, yet the operator must absorb the reaction force when the tool is operated without a reaction fixture. The turning force cannot exceed low torque values. Otherwise the operator's arm would succumb to the reaction force and twist once the tool applies a torque to overcome adverse bolting application characteristics. In many instances, this tool must react against a stationary object to achieve torque values sufficient to overcome adverse bolting application characteristics, obviously at lower speed.

Current tooling limitations force operators to use two tools: an impact wrench to run down or off a nut, in the absence of adverse bolting application characteristics, because of high impact force, high rotation speed and low reaction force; and a torque wrench with a reaction fixture to tighten or loosen the nut because of accurate and measurable high torque. Impact wrenches are no longer acceptable at high torque due to inaccuracy and vibration, which is a cause of tennis elbow. And torque wrenches are no longer acceptable at low torque due to low speed.

The present invention has therefore been devised to address these issues.

According to a first aspect of the invention we provide an apparatus for reaction-free and reaction-assisted tightening and loosening of an industrial fastener including:
a motor to generate a turning force to turn the fastener;
a turning force multiplication mechanism for a lower speed/higher torque mode including a plurality of turning force multiplication transmitters;
a turning force impaction mechanism for a higher speed/lower torque mode including a plurality of turning force impaction transmitters;
a housing operatively connected with at least one multiplication transmitter;
a reaction mechanism to transfer a reaction force generated on the housing during the lower speed/higher torque mode to a stationary object;
wherein during the lower speed/higher torque mode at least two multiplication transmitters rotate relative to the other; and
wherein during the higher speed/lower torque mode at least two multiplication transmitters are unitary to achieve a hammering motion from the impaction mechanism.

Further features of the invention are set out in claims 2 to 35 appended hereto.

Advantageously, this invention addresses industrial concerns and issues with a tool that: generally falls below recommended vibration exposure action values because the impaction mechanism impacts only in the first mode—at low speed, high torque the impaction mechanism does not impact and therefore does not vibrate; provides a high inertia in the first mode due to a high mass from cooperation between the multiplication and impaction mechanisms, which increases the torque output of the impaction mechanism; runs down and runs off fasteners at high speed without the use of a reaction fixture even when a torque higher than the one absorbable by an operator is required to overcome adverse bolting application characteristics; and loosens highly torqued or corroded fasteners that are stuck to their joints and tightens fasteners to a desired higher and more precise torque with use of a reaction fixture in the second mode.

The invention may be described by way of example only with reference to the accompanying drawings, of which:

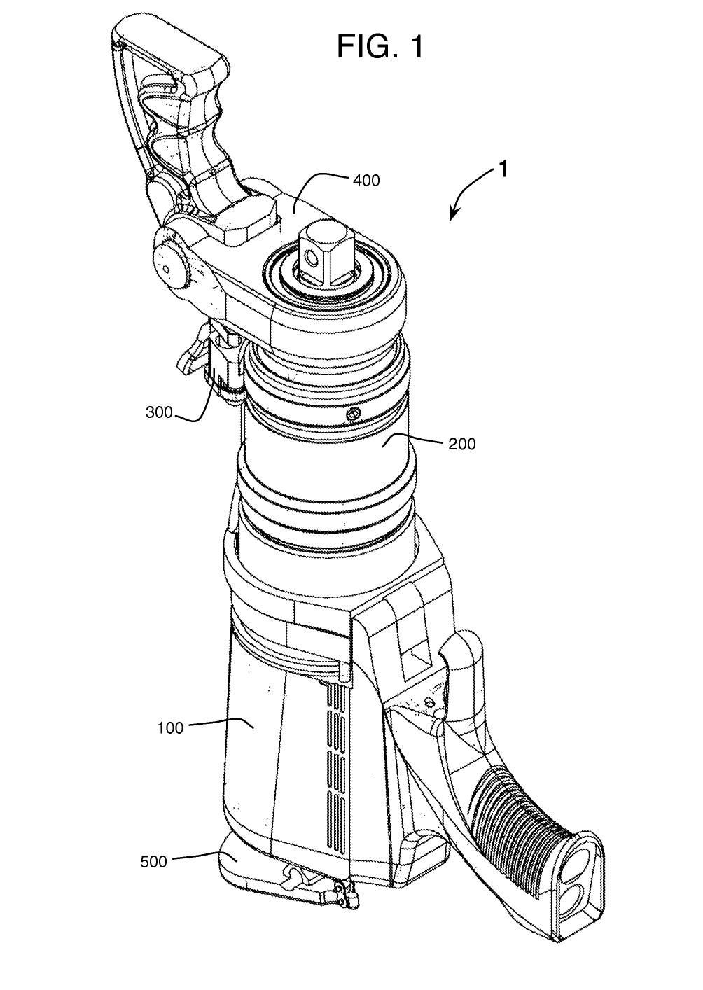

FIG. 1 is a perspective view of an embodiment of the present invention;

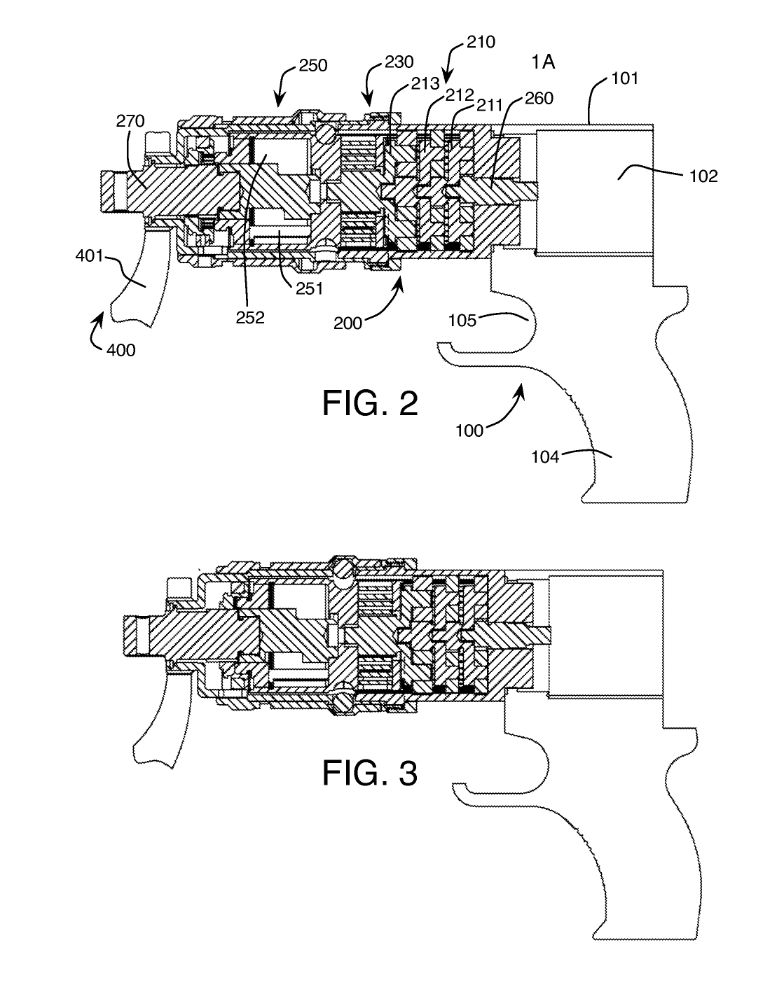

FIG. 2 is a side, cross-sectional view, of an embodiment of the present invention;

FIG. 3 is a side, cross-sectional view, of an embodiment of the present invention;

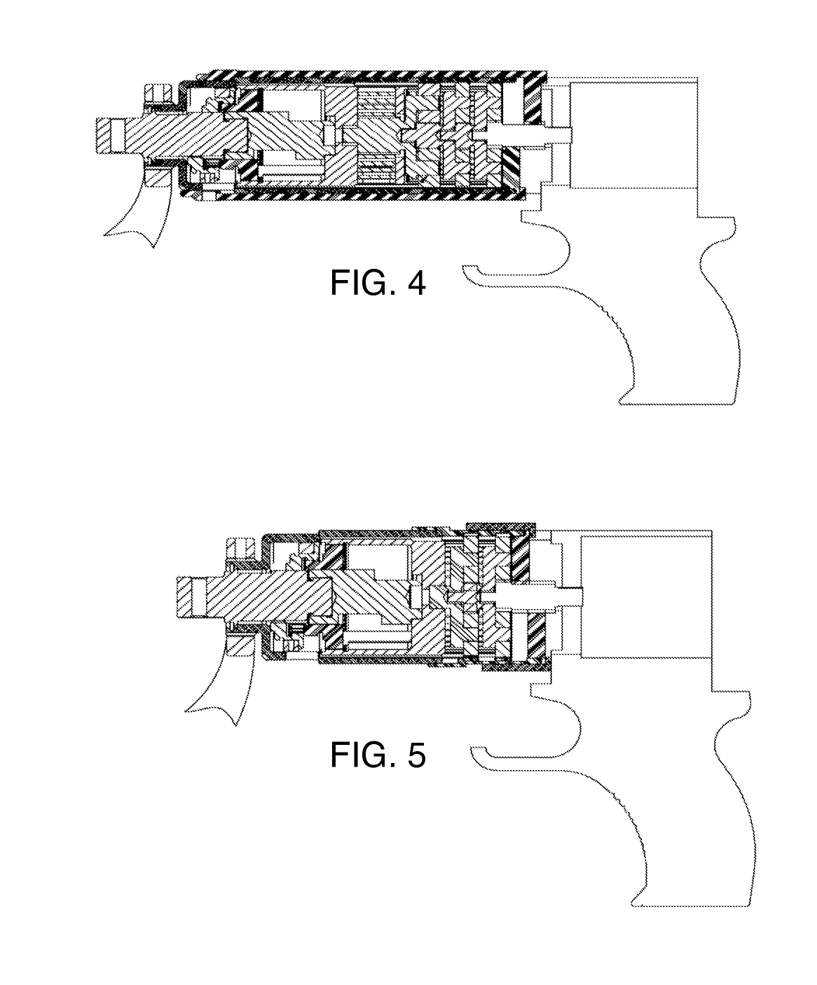

FIG. 4 is a side, cross-sectional view, of an embodiment of the present invention;

FIG. 5 is a side, cross-sectional view, of an embodiment of the present invention;

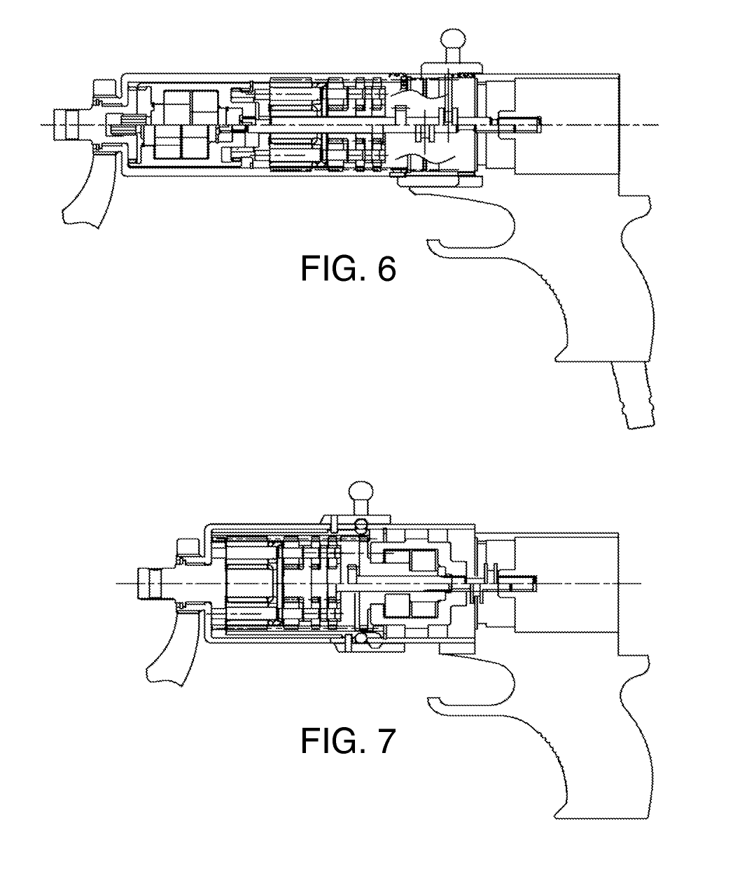

FIG. 6 is a side, cross-sectional view, of an embodiment of the present invention; and

FIG. 7 is a side, cross-sectional view, of an embodiment of the present invention.

Referring to FIG. 1 by way of example, this shows a perspective view of an embodiment of the present invention as an apparatus 1 for reaction-free and reaction-assisted tightening and loosening of an industrial fastener. Apparatus 1 includes: a drive assembly 100; an intensification assembly 200; a gear/mode shifter assembly 300; a swivel/flip reaction assembly 400; and a safety assembly 500.

Referring to FIG. 2 by way of example, this shows a cross-sectional view of an embodiment of the present invention as apparatus 1A. Apparatus 1A is similar to apparatus 1 as noted by duplication of reference numbers.

Drive assembly 100 may include a drive housing 101, a drive mechanism 102, a handle 104, and a switching mechanism 105. Drive means 102 generates a turning force to turn the fastener and is shown formed as a motor drive means which includes a motor. Drive mechanism 102 may also be formed as a manual drive mechanism, such as a torque wrench. Drive mechanism 102 generates a torque for operation of apparatus 1A. Drive housing 101 is shown as a cylindrical body with handle 104 which is held by an operator and provided with switching mechanism 105 for switching motor 102 on and off.

Intensification assembly 200 includes a turning force multiplication mechanism 210 substantially for a lower speed/higher torque mode including a plurality of turning force multiplication transmitters. In this embodiment intensification assembly 200 includes three multiplication transmitters 211, 212 and 213. Multiplication transmitters 211, 212 and 213 may include gear cages; planetary gears; ring gears; sun gears; wobble gears; cycloidal gears; epicyclic gears; connectors; spacers; shifting rings retaining rings; bushings; bearings; caps; transmission gears; transmission shafts; positioning pins; drive wheels; springs; or any combination thereof. Multiplication transmitters 211, 212 and 213 may include other known like components as well.

It is to be understood that there are various known impaction mechanisms, yet for the most part they consist of an anvil and a turning hammer. The hammer is turned by the motor and the anvil has a turning resistance. This causes a hammering action, which is passed on to the output drive. Intensification assembly 200 includes a turning force impaction mechanism 250 substantially for a higher speed/lower torque mode including a plurality of turning force impaction transmitters. In this embodiment intensification assembly 200 includes two turning force impaction transmitters 251 and 252. Impaction transmitters 251 and 252 may include hammers; anvils; connectors; spacers; shifting rings retaining rings; bushings; bearings; caps; transmission gears; transmission shafts; positioning pins; drive wheels; springs; or any combination thereof. Impaction transmitters 251 and 252 may include other known like components as well.

Known torque intensifier tools are usually powered by air, electric, hydraulic or piston motors. Often the force output and rotation speed is increased or decreased by means of planetary gears or the like, which become part of the motor. Some known tools temporarily eliminate one or several of the intensifier means to increase the tool motor rotation speed. Other known tools use gear intensification and/or reduction mechanisms as stand alone components or adjacent the motor to increase and/or decrease shaft rotation speed. The present invention may also include such gear intensification and/or reduction mechanisms as stand alone components, as multiplication transmitters and part of multiplication mechanism 210 or as impaction transmitters and part of impaction mechanism 250.

Intensification assembly 200 includes an intensification housing 220 operatively connected with at least one multiplication transmitter. Apparatus 1A includes a reaction mechanism 401 of reaction assembly 400, which is not fully shown in FIGS. 2-7. Reaction mechanism 401 transfers a reaction force generated on housing 220 during the lower speed/higher torque mode to a stationary object.

Generally operation of apparatus 1A requires activation or deactivation of impaction mechanism 250 which can be done manually with a switch. Apparatus 1A includes a switching mechanism 230 of intensification assembly 200 shift apparatus 1A between either: multiplication mechanism 210; impaction mechanism 250; part of multiplication mechanism 210 (such as for example one of the plurality of multiplication transmitters); part of impaction mechanism 250 (such as for example one of the plurality of impaction transmitters); or any combination thereof. Switching mechanism 230 may include: shifting collars; shifting rings; ball bearings; bearings; retaining rings; or any combination thereof. Switching mechanism 230 may include other known like components as well.

In operation the RPMs of apparatus 1A decrease as torque output increases. The activation or deactivation of impaction mechanism 250 alternatively may be automated such that when the RPMs drop below or go beyond a predetermined number, impaction mechanism 250 becomes ineffective or effective. To make the impact mode for industrial fasteners effective it is recommended to take a hammer and anvil device as known, which consists of an impact housing, at least one hammer and an anvil that is usually connected with the tool output drive that turns the fastener.

Apparatus 1A includes an input shaft 260 to assist in transfer of the turning force from motor 102 to either: multiplication mechanism 210; impaction mechanism 250; part of multiplication mechanism 210 (such as for example one of the plurality of multiplication transmitters); part of impaction mechanism 250 (such as for example one of the plurality of impaction transmitters); or any combination thereof. Apparatus 1A includes an output shaft 270 to assist in transfer of the turning force to the industrial fastener via an output drive from either: multiplication mechanism 210; impaction mechanism 250; part of multiplication mechanism 210 (such as for example one of the plurality of multiplication transmitters); part of impaction mechanism 250 (such as for example one of the plurality of impaction transmitters); or any combination thereof.

Generally apparatus of the present invention make use of an impaction mechanism and a multiplication mechanism. In the higher speed/lower torque first mode the impaction mechanism acts to provide a turning force to a hammer. In a lower speed/higher torque second mode the impaction mechanism acts as an extension to pass on the turning force from one part of the tool to another. The impaction mechanism can be located either close to the tool motor, close to the tool output drive or anywhere in between.

In the first mode, the impaction mechanism always receives a turning force and turns; the housing may or may not receive a turning force; and the torque output is relatively low, which is why the housing does not need to react. Note that in most embodiments of the present invention, the impaction mechanism is operable only in high speed. This in turn means that at low speed when the torque intensifier mechanism is operable, there is no impact so that there is also no vibration under high torque. Generally, as shown in FIG. 2, at least two multiplication transmitters are unitary to achieve a hammering motion from the impaction mechanism.

The following discussion relates to FIGS. 2-7. Note that like terms are interchangeable, such as for example: intensifier, multiplier and multiplication; impact and impaction.

More specifically, in one embodiment of the impact mode, the tool housing and the gear stages stand still while the impact rattles. When the impact mechanism is distant from the motor, a shaft from the motor goes through the center of the multipliers to the impact mechanism and from there to the output drive. When the impact mechanism is immediately after the motor and in front of the multipliers the motor drives the impact mechanism and a shaft goes from the impact mechanism through the center of the multipliers to the output drive

In another embodiment of the impact mode, the tool housing and the gear stages rotate in unison while the impact rattles by locking up the gear stages. This may be accomplished by connecting either: the sun gear with the ring gear; the sun gear with the gear cage; or the gear cage with the ring gear of a planetary stage. In each case all gear cages and the housing act like one turning extension from the motor to the impact mechanism or from the impact mechanism to the output drive of the tool.

In another embodiment of the impact mode, the tool housing stands still and the gear cages rotate in unison while the impact rattles by locking up the gear cages with one another. When the impact mechanism is distant from the motor the gear cage(s) act like an extension inside the housing from the motor to the impact mechanism. When the impact mechanism is immediately after the motor and in front of the multipliers the gear cages or gear cage act like an extension inside the housing from the impact mechanism to the output drive of the tool.

Generally during the lower speed/higher torque second mode, as shown in FIG. 3, at least two multiplication transmitters rotate relative to the other. In the multiplier mode, the tool housing always rotates opposite to the sun gears and the output shaft of the multipliers, which is why the tool housing has to react. When torque is intensified by the multiplier, the turning speed is so slow that the impact mechanism is ineffective. If the impact mechanism is located after the multiplier and close to the output drive of the tool, the impact mechanism will not impact if it turns with the last sun gear. If the impact mechanism is located before the multiplier and close to the motor, the impact mechanism turns at high speed and needs to be locked.

In one embodiment where the impact mechanism is distant from the motor, the following occurs: the impact mechanism stands still while the multipliers turn; the output shaft from the motor goes to the multiplier for torque multiplication; and the last sun gear extends through the impact mechanism to the output drive. When the impact mechanism is immediately after the motor and in front of the multipliers, the output shaft from the motor goes through the impact mechanism to the multiplier for torque multiplication and the last sun gear extends to the output drive.

In another embodiment, the impact mechanism turns at the speed of the last sun gear of the force applying multipliers. When the impact mechanism is distant from the motor, the output shaft from the motor goes to the multiplier for torque multiplication and the last sun gear turns the impact mechanism, which turns the output shaft of the tool.

When the impact mechanism is immediately after the motor and in front of the multipliers, turning the impact mechanism to turn the multipliers would result in impacting, which is to be avoided. On the other hand, the impact mechanism can be locked by locking the hammer with the impact housing, or by locking the hammer with the anvil. The impact mechanism acts as an extension between the motor output drive and the first sun gear of the multiplier.

The speed of the last sun gear of the multiplier may be high enough to operate the impact mechanism. Impaction on the output shaft of the tool is avoidable by locking the hammer with the impact housing, the hammer with the anvil, the impact housing with the tool housing or the hammer with the tool housing.

In a specific embodiment of the first mode, as for example shown in the top half of FIG. 6, the multiplication mechanism is close to the motor and before the impaction mechanism. The motor bypasses the multiplication mechanism and extends its output force through at least one part of the multiplication mechanism by means of a pin toward the output drive. In a specific embodiment of the first mode, as for example shown in the top half of FIG. 7, the impact mechanism is close to the motor and before the multiplication mechanism. The impaction mechanism extends its output force through at least one part of the multiplication mechanism by means of a pin toward the output drive.

One embodiment of a complete tool of the present application may include a motor housing having an impact mechanism right after the air motor, which has a hole through it. A pin that sticks out through the rear plate of the tool and is connected to a safety plate as described and claimed in U.S. application Ser. No. 12/120,346, having a Filing Date of May 14, 2008, entitled “Safety Torque Intensifying Tool”. The pin is for example spline connected to the motor and movable along its axis. The front of the pin turns the hammer of the impact mechanism. The output drive of the impact mechanism is splined but has a round diameter portion between the splined portion and where it comes out of the impact mechanism.

A planetary housing has inner splines called a ring gear. A round plate with outer splines is connected to the end of the planetary housing just in front of the first gear stage and the output drive of the impact mechanism engages in a female spline in the round plate and acts also as first sun gear. The round plate has a groove on top of the spline. Two thin plates having a hole on one end and having a perpendicular part going through two slots in the motor housing handle to connect with the two pins that move axially backward when the safety plate is pushed to engage a reaction arm. Such reaction arms are described and claimed in: U.S. application Ser. No. 11/745,014, having a Filing Date of May 7, 2007, entitled “Power-Driven Torque Intensifier”; U.S. Pat. No. 7,798,038, having Issue Date of Sep. 21, 2010, entitled “Reaction Arm For Power-Driven Torque Intensifier”; and U.S. application Ser. No. 12/325,815, having a Filing Date of Dec. 1, 2008, entitled “Torque Power Tool”. The holes have a ball bearing in them to connect the round plate with the plates. In high speed this means that the planetary housing is free to rotate relative to the motor housing handle. For rundown, when the safety plate is not pushed in and when the speed lever is pushed down, the impact mechanism impacts.

When the speed lever is released, the reaction arm is placed in position and the safety plate is pushed, the following happens simultaneously: an engagement plate moves from the splined portion of the output drive to its round diameter portion; the engagement plate disengages from the planetary housing and moves into the motor housing handle; the reaction arm engages; the pin moves forward and connects with the anvil to make the impaction mechanism non-functioning but turnable as a unit to turn the planet gears. The planetary housing is free to rotate relative to the motor housing handle.

Referring back to FIG. 1, components of apparatus 1 may further be explained with reference to technology disclosed in the following commonly owned issued patents and patent applications, entire copies of which are incorporated herein by reference: U.S. application Ser. No. 11/745,014, having a Filing Date of May 7, 2007, entitled “Power-Driven Torque Intensifier”; U.S. Pat. No. 7,798,038, having Issue Date of Sep. 21, 2010, entitled “Reaction Arm for Power-Driven Torque Intensifier”; U.S. application Ser. No. 12/120,346, having a Filing Date of May 14, 2008, entitled “Safety Torque Intensifying Tool”; U.S. application Ser. No. 12/325,815, having a Filing Date of Dec. 1, 2008, entitled “Torque Power Tool”; and U.S. application Ser. No. 12/428,200, having a Filing Date of Apr. 22, 2009, entitled “Reaction Adaptors for Torque Power Tools and Methods of Using the Same”.

It will be understood that each of the elements described above, or two or more together, may also find a useful application in other types of constructions differing from the types described above. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof. While the invention has been illustrated and described as embodied in a fluid operated tool, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention. When used in this specification and claims, the terms “comprising”, “including”, “having” and variations thereof mean that the specified features, steps or integers are included. The terms are not to be interpreted to exclude the presence of other features, steps or components.

What is claimed is:

1. A power tool for reaction-free and reaction-assisted tightening and loosening of an industrial fastener including:
a motor to generate a turning force to turn the fastener;
a turning force multiplication mechanism for a lower speed/higher torque mode including a plurality of turning force multiplication transmitters;
a turning force impaction mechanism for a higher speed/lower torque mode including a plurality of turning force impaction transmitters;
a housing operatively connected with at least one multiplication transmitter;
a reaction mechanism to transfer a reaction force generated on the housing during the lower speed/higher torque mode to a stationary object;
wherein during the lower speed/higher torque mode at least two multiplication transmitters rotate relative to the other; and
wherein during the higher speed/lower torque mode at least two multiplication transmitters are unitary to achieve a hammering motion from the impaction mechanism.

2. The power tool of claim 1 including a switch to shift the tool between either:
the multiplication mechanism;
the impaction mechanism;
part of the multiplication mechanism;
part of the impaction mechanism; or
any combination thereof.

3. The power tool of claim 1 including:
an input shaft to assist in transfer of the turning force from the motor to either:
the multiplication mechanism;
the impaction mechanism;
part of the multiplication mechanism;
part of the impaction mechanism; or
any combination thereof;
an output shaft to assist in transfer of the turning force to the industrial fastener via an output drive from either:
the multiplication mechanism;
the impaction mechanism;
part of the multiplication mechanism;
part of the impaction mechanism; or
any combination thereof.

4. The power tool of claim 1 wherein the multiplication transmitters include either:
gear cage;
planetary gear;
ring gear;
sun gear;
wobble gear;
cycloidal gear;
epicyclic gear; or
any combination thereof.

5. The power tool of claim 1 wherein the impaction transmitters include a hammer and an anvil.

6. The power tool of claim 1 wherein during the lower speed/higher torque mode either:
at least two impaction transmitters are still; or
at least two impaction transmitters and at least one multiplication transmitter rotate together.

7. The power tool of claim 1 wherein during the higher speed/lower torque mode at least two impaction transmitters rattle and either:
the housing and the at least two multiplication transmitters are still;
the housing and the at least two multiplication transmitters rotate together; or
the housing is still and the at least two multiplication transmitters rotate together.

8. The power tool of claim 6 wherein the at least two impaction transmitters are still when the motor is proximate to the impaction mechanism which is proximate to the multiplication mechanism because the output shaft bypasses the impaction mechanism and the at least one multiplication transmitter extends to the output drive.

9. The power tool of claim 6 wherein the at least two impaction transmitters are still when the motor is proximate to the multiplication mechanism which is proximate to the impaction mechanism because the output shaft contacts the multiplication mechanism and the at least one multiplication transmitter bypasses the at least two impaction transmitters and extends to the output drive.

10. The power tool of claim 6 wherein the at least two impaction transmitters and the at least one multiplication transmitter rotate together when the motor is proximate to the multiplication mechanism which is proximate to the impaction mechanism because the output shaft contacts the multiplication mechanism and the at least one multiplication transmitter turns the at least two impaction transmitters and extends to the output drive.

11. The power tool of claim 6 wherein the at least two impaction transmitters and the at least one multiplication transmitter rotate together when the motor is proximate to the impaction mechanism which is proximate to the multiplication mechanism because the impaction mechanism acts as a conduit between the input shaft and the at least one multiplication transmitters by locking either:
at least one impaction transmitter with a housing of the impaction mechanism; or
at least one impaction transmitter with at least another of the impaction transmitters.

12. The power tool of claim 10 wherein operation of the impaction mechanism by a rotation speed of the at least one multiplication transmitter is avoidable by locking either:
at least one impaction transmitter with a housing of the impaction mechanism;
at least one impaction transmitter with at least another of the impaction transmitters; or
at least one impaction transmitter with a housing of the multiplication mechanism.

13. The power tool of claim 7 wherein the housing and the at least two multiplication transmitters are still when the motor is proximate to the impaction mechanism which is proximate to the multiplication mechanism because the output shaft bypasses the multiplication mechanism.

14. The power tool of claim 7 wherein the housing and the at least two multiplication transmitters are still when the motor is proximate to the multiplication mechanism which is proximate to the impaction mechanism because the motor drives the impaction mechanism by the input shaft and the output shaft bypasses the multiplication mechanism.

15. The power tool of claim 7 wherein the housing and the at least two multiplication transmitters rotate together when the motor is proximate to the impaction mechanism which is proximate to the multiplication mechanism because the multiplication mechanism acts as a conduit from the impaction mechanism to the output drive by connecting either:
the sun gear with the ring gear;
the sun gear with the gear cage; or
the gear cage with the ring gear.

16. The power tool of claim 7 wherein the housing and the at least two multiplication transmitters rotate together when the motor is proximate to the multiplication mechanism which is proximate to the impaction mechanism because the multiplication mechanism acts as a conduit from the motor to the impaction mechanism by connecting either:
the sun gear with the ring gear;
the sun gear with the gear cage; or
the gear cage with the ring gear.

17. The power tool of claim 7 wherein the housing is still and the at least two multiplication transmitters rotate together when the motor is proximate to the impaction mechanism which is proximate to the multiplication mechanism because the multiplication mechanism acts as a conduit inside the housing from the impaction mechanism to the output drive by connecting either:
the sun gear with the ring gear;
the sun gear with the gear cage; or
the gear cage with the ring gear.

18. The power tool of claim 7 wherein the housing is still and the at least two multiplication transmitters rotate together when the motor is proximate to the multiplication mechanism which is proximate to the impaction mechanism because the multiplication mechanism acts as a conduit inside the housing from the motor to the impaction mechanism by connecting either:
the sun gear with the ring gear;
the sun gear with the gear cage; or
the gear cage with the ring gear.

19. The power tool of claim 15 wherein the at least two multiplication transmitters are unitary to assist with a hammering motion from the impaction mechanism.

20. The power tool of claim 1 wherein the multiplication mechanism either includes or excludes gear reduction either proximate to or distant from the motor.

21. The power tool of claim 2 wherein the switch is manual or automatic.

22. The power tool of claim 2 wherein the switch requires one hand of an operator on it while an other hand of the operator pulls a trigger.

23. The power tool of claim 3 wherein the switch is automated by a torque requirement of the output drive, so that when the torque requirements are high the multiplication mechanism is substantially and the impaction mechanism merely passes on the torque derived from the multiplication mechanism to the output drive, whereas when the torque requirements are relatively low the impaction mechanism is operated substantially separated from the multiplication mechanism.

24. The power tool of claim 2 including:
the housing having at least a first and a second housing portion;
the first housing portion including the impaction mechanism, partially or completely;
the second housing portion including the multiplication mechanism, partially or completely;
wherein during substantially the higher speed/lower torque mode the motor either turns the output drive continuously at high speed or intermittently at low speed, the at least first and second housing portions are connected so as to allow rotation relative to the other; and
wherein during substantially the lower speed/higher torque mode the motor turns the output drive continuously at high and precise torque, the at least first and second housing portions are connected so as to allow rotation in unison.

25. The power tool of claim 2 including:
the housing having at least a first and a second housing portion;
the first housing portion including the impaction mechanism, partially or completely;
the second housing portion including the multiplication mechanism, partially or completely;
wherein during substantially the higher speed/lower torque mode the at least first and second housing portions are connected so as to allow rotation relative to the other; and
wherein during substantially the lower speed/higher torque mode the at least first and second housing portions are connected so as to allow rotation in unison.

26. The power tool of claim 1 including three multiplication transmitters.

27. The power tool of claim 1 including three impaction transmitters.

28. A power tool for reaction-free and reaction-assisted tightening and loosening of an industrial fastener including:
a motor to generate a turning force to turn the fastener;
a turning force multiplication mechanism for a lower speed/higher torque mode including three turning force multiplication transmitters:
a turning force impaction mechanism for a higher speed/lower torque mode including two turning force impaction transmitters:
a housing operatively connected with at least one multiplication transmitter;
a reaction mechanism to transfer a reaction force generated on the housing during the lower speed/higher torque mode to a stationary object;
a switch to shift the tool between either:
the multiplication mechanism;
the impaction mechanism;
part of the multiplication mechanism;
part of the impaction mechanism; or
any combination thereof;
an input shaft to transfer the turning force from the motor to either:
the multiplication mechanism;
the impaction mechanism;
part of the multiplication mechanism;
part of the impaction mechanism; or
any combination thereof;
an output shaft to transfer the turning force to the fastener via an output drive from either:
the multiplication mechanism;
the impaction mechanism;
part of the multiplication mechanism;
part of the impaction mechanism; or
any combination thereof;
wherein during the lower speed/higher torque mode at least two multiplication transmitters rotate relative to the other; and
wherein during the higher speed/lower torque mode at least two multiplication transmitters are unitary.

29. A power tool, including:
a housing;
a motor;
a torque intensifier mechanism including a gear cage, a planetary gear, a ring gear and a sun gear, which multiplies a torque input from the motor for high and precise torque output such that the housing and the torque intensifier mechanism rotate in opposite directions requiring the housing to react on a stationary object to pass the turning force onto an industrial fastener during tightening or loosening of the fastener;
an impact mechanism including a hammer and anvil such that the housing and the torque intensifier mechanism rotate in the same direction creating a turning mass greater than that derived from the motor which increases an impacting force the hammer applies to the anvil so that with a relative low torque input from the motor the torque output from the impact mechanism is increased during running up or running down the fastener; and
wherein the torque intensifier mechanism and the impact mechanism are operable either partially or completely either together or separately during tightening or loosening of an industrial fastener.

30. A power tool which can produce torque output in excess of a reaction force absorbable by a tool operator, including:
a housing with a reaction portion;
a motor;
a torque intensifier means;
an impact means;
an output drive;
means for either partially or completely switching from the torque intensifier means to the impact means by disengaging one, either partially or completely, and engaging the other, either partially or completely, or visa versa;
the torque intensifier means and the impact means being operable partially or separately together during tightening or loosening of an industrial fastener;
wherein the impact means:
provides a hammering reaction free torque to assure hand held operation at a torque lower than the torque derived by said intensifier means to assure low vibration;
when inoperable, provides no hammering action to the torque intensifier means to achieve the desired higher torque output, but is made to coordinate the force derived from the motor and the intensifier means with the output drive;
wherein the torque intensifier means:
provides a vibration-free, continuously rotating higher torque action requiring a reaction fixture on the reaction portion to stop the housing from rotating; and
when inoperable, provides no increase to the torque output of the impact means, but is made to coordinate the force derived from the motor and the impact means with the output drive.

31. A power tool for an industrial fastener, including:
a motor;
a torque intensifier mechanism which multiplies a torque input from the motor for high and precise torque output;
an impact mechanism of the hammer and anvil type;
the power tool having at least two modes, including:
an impact mode, useable at least during run down or run off of the fastener, where an operator holds the tool by a manual tool holding mechanism to overcome thread irregularities of the fastener requiring a higher torque than that which is absorbable by the operator;
an intensifier mode, useable at least during tightening or loosening of the fastener, where a tool abutment mechanism holds the tool stationary to provide a higher and more precise torque than that of the first mode; and
wherein the manual tool holding mechanism and the tool abutment mechanism are one and the same and movable from the impact mode to the intensifier mode.

32. A power tool, including:
a housing;
a motor;
a torque intensifier mechanism which multiplies a torque input from the motor for high and precise torque output;
an impact mechanism of the hammer and anvil type;
the torque intensifier mechanism and the impact mechanism being operable separately during tightening or loosening of an industrial fastener;
the torque intensifier mechanism is operated when higher and more precise torque is required during tightening or loosening of the industrial fastener such that the housing and the torque intensifier mechanism rotate in opposite directions requiring the housing to react on a stationary object to pass the turning force onto the fastener; and
the impact mechanism is operated when lower and less precise torque is required during running up or running down of the industrial fastener such that the housing and the torque intensifier mechanism rotate in the same direction creating a turning mass greater than that derived from the motor which increases a hammer force the hammer applies to the anvil so that with a relative low torque input from the motor the torque output from the impact mechanism is increased.

33. (canceled)

34. (canceled)

35. (canceled)
